(19) United States
(12) Patent Application Publication
(10) Pub. No.: US 2014/0132044 A1
(43) Pub. Date: May 15, 2014

(54) PORTABLE SLING FOR SECURELY HOLDING A FOOD OR WATER CONTAINER TO SERVICE KIDS OR ANIMALS DURING AUTO TRAVEL

(71) Applicant: Pamela Vera Louie, Tracy, CA (US)

(72) Inventor: Pamela Vera Louie, Tracy, CA (US)

(21) Appl. No.: 14/078,472

(22) Filed: Nov. 12, 2013

Related U.S. Application Data
(60) Provisional application No. 61/725,309, filed on Nov. 12, 2012.

(51) Int. Cl. B60R 7/04

(52) U.S. Cl. CPC B60R 7/043
USPC 297/188.2

(57) ABSTRACT

The new portable auto sling attaches to the front or back of a vehicle seat to securely hold food or water for pet access during travel. The sling includes a generally boxy body constructed of a flexible material with a removable, rigid insert that provides a sturdy, horizontal base to support a bowl or dish. Alternatively, the sling can be used for storage of items such as children's toys, pet items or entertainment devices, and it can be used nearly any place use is desirable, including in a vehicle, at home or in the office.

### CROSS-REFERENCE TO RELATED APPLICATIONS

This application claims the benefit of U.S. Provisional Application for Patent Ser. No. 61/725,309, filed on Nov. 12, 2012.

### FEDERALLY-SPONSORED RESEARCH

Not applicable.

### SEQUENCE LISTING

Not applicable.

### BACKGROUND

Common challenges presented during auto travel with animals include: dehydration, exposure to water-borne germs such as Giardia, Cryptosporidium or Leptospirosis that may be found in public or communal water sources, inconvenience, spillage of water or food in free-standing containers in a moving vehicle, and inaccessibility. The novel portable auto sling is designed to address these issues by holding a food or water container securely and at a height accessible to an animal sitting on a backseat or in the back of a vehicle behind the rear seat. The sling also prevents mess in the vehicle because it acts as a reservoir for any spillage caused by the animal during eating or drinking.

Without the auto sling, current options for watering or feeding during travel generally include 1) stopping so the animal can drink or eat outside of the vehicle, which adds delay to travel time, or 2) placing a water or food dish on the seat or floorboard for the animal to access while the vehicle is moving, which is almost certain to cause spillage, mess and waste. The new device eliminates the need for additional stops to feed or water an animal and enables comfortable access to food or water during travel while keeping the vehicle clean from spillage.

The portable auto sling is also suitable for holding food and drinks for children or adults riding in a vehicle.

### SUMMARY OF THE INVENTION

The claimed invention is, generally, a sling with a reservoir, solid base and access window that is positioned and stabilized behind a car seat via attachment primarily around the headrest and optionally and secondarily tethering around or beneath a car seat.

The new auto sling benefits animals by enabling provision of a convenient and clean water or food source during auto travel, and the device benefits animal owners by enabling watering and feeding during travel as to reduce time-consuming stops, and its stable base and positioning system prevent spills within the vehicle.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIG. 1 shows the front-top-side view of one embodiment of the portable auto sling.

FIG. 2 shows the back-top-side view of one embodiment of the portable auto sling.

FIG. 3A shows one embodiment of the portable auto sling attached and tethered horizontally to a car seat.

FIG. 3B shows one embodiment of the portable auto sling attached and tethered vertically to a car seat.

### DETAILED DESCRIPTION

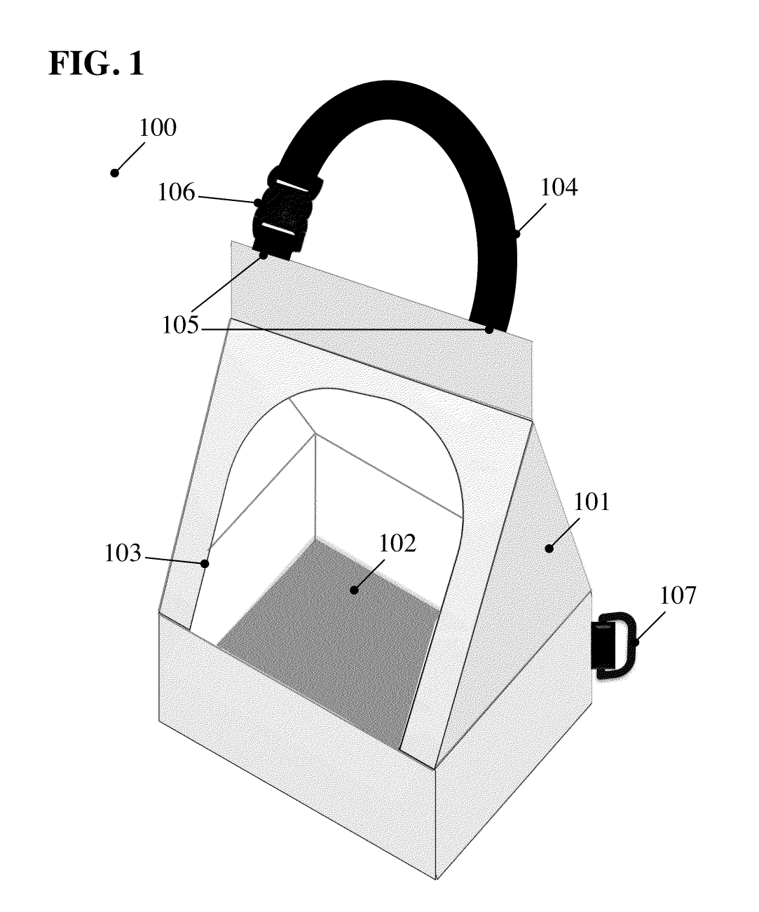

FIG. 1 is the front-top-side view 100 of one embodiment of the portable sling 101. In this embodiment, the sling has a generally triangular top and a boxy bottom designed to receive a removable, rigid support element (such as high-density polyurethane, which is resistant to heat and cold) 102, which provides a steady, horizontal platform suitable for supporting a bowl or dish of water or food. While the sling can be constructed of any suitable material, the preferred material is a flexible and waterproof or water-resistant material that enables compact folding and storage of the sling while not in use, as well as leakage prevention and convenient cleaning. The sling 101 further comprises an opening 103 large enough to allow access to the contents of the sling by an animal's head or muzzle or, likewise, a passenger's hand. In the present embodiment, the sling attaches to a car seat via a top strap 104 having two connection points on the sling 105 and a means for adjusting the strap's length, as well as a means for opening and re-connecting the strap 106, such as a parachute clip. This embodiment also includes a side attachment means 107 whereby a secondary strap can connect and secure the sling to a vehicle seat by wrapping around the seat horizontally.

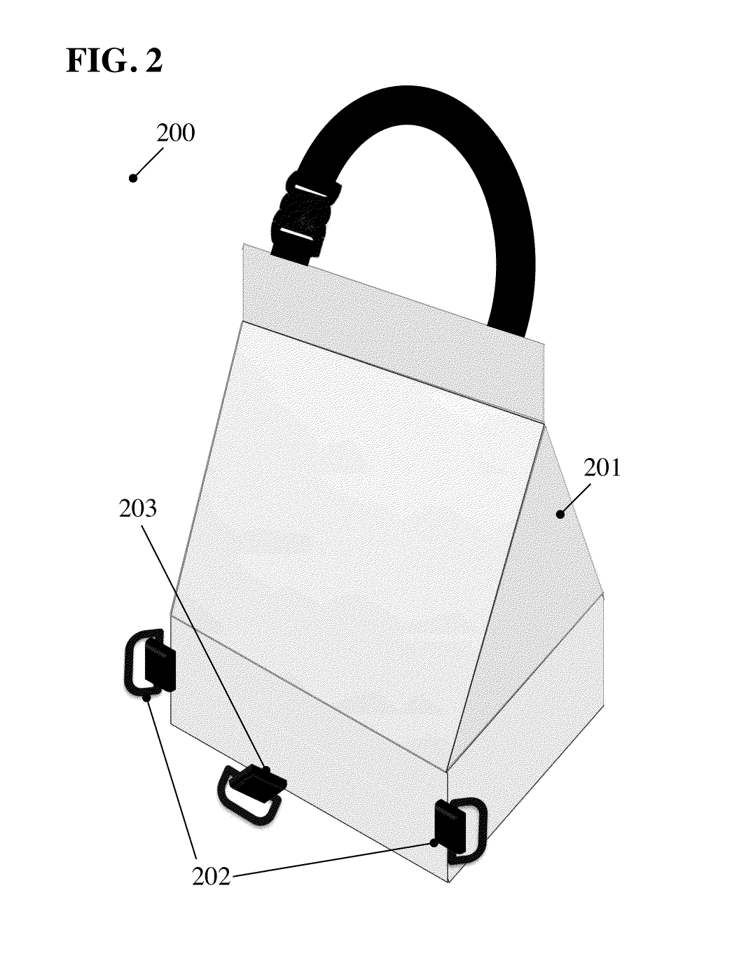

FIG. 2 is the back-top-side view 200 of the embodiment of the portable sling 201 presented in FIG. 1, which better shows the lower strap side attachment means 202, as well as a single lower strap attachment means 203 for vertical tethering to a vehicle seat for added stability.

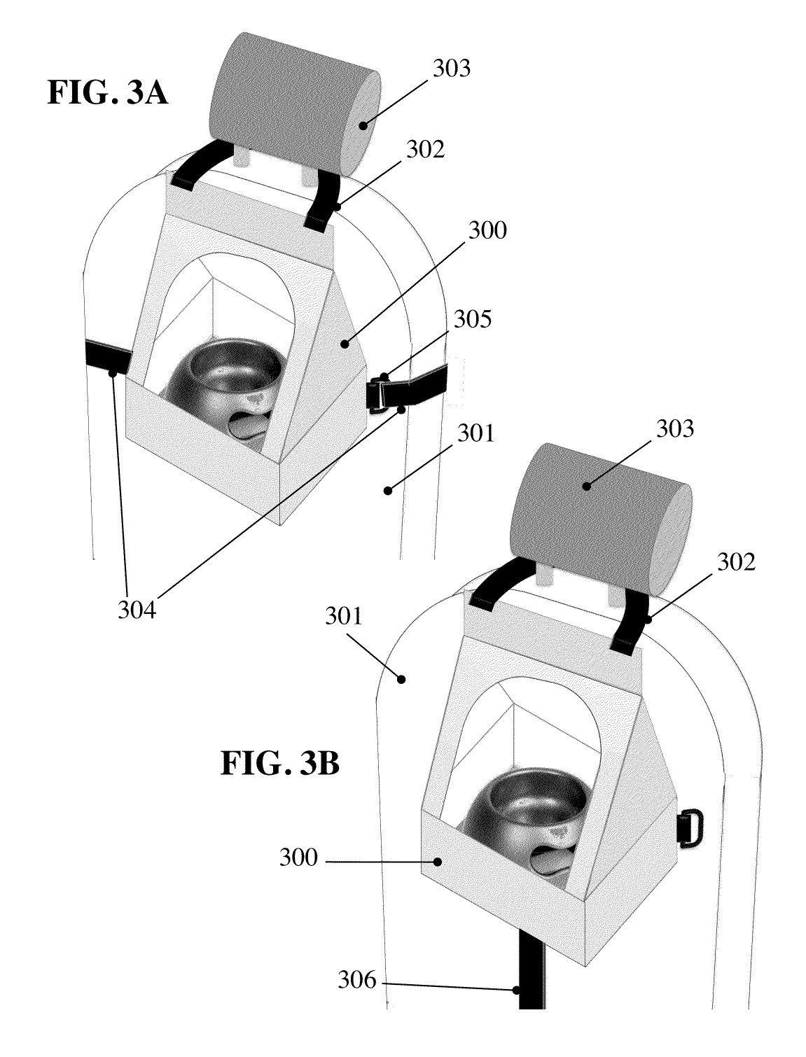

FIGS. 3A and 3B demonstrate two methods for how the preferred embodiment of the sling 300 is used in connection with a vehicle seat 301. In FIG. 3A, the sling 300 is hung via an adjustable top strap 302 from a car seat headrest 303 and tethered to the seat 301 for added stability via an adjustable lower strap 304 that wraps horizontally around the body of the seat 301 and attaches to the sling at two attachment points (rings) 305 located on opposing sides of the sling. In FIG. 3B, the sling 300 is hung via an adjustable top strap 302 from a car seat headrest 303 and tethered to the seat 301 for added stability via an adjustable lower strap 306 that connects the sling to the chair by attaching at one end to the sling at a single attachment point (ring; shown as 205 in FIG. 2) on or near the bottom of the sling and attaching at the other end to an attachment point near the bottom or beneath the seat. While the use demonstrated in FIG. 3A is suitable for use on the front or back of a car seat, the use demonstrated in FIG. 3B is better suited for use on the back of a seat. In both uses, the structurally reinforced base of the sling provides a stable platform on which a food, water or other container can be placed and easily accessed by an animal or human passenger.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a portable sling that:
Attaches to a vehicle seat to provide pets and passengers convenient and mess-free access to food and water during travel;
May be made in any size required to service the target animal(s) or passenger, ranging from small for a small cat or dog to large for use in a horse trailer for feeding or watering a horse during travel or storage;
Can be used for storage of items such as children's toys and pet items;
Can be used nearly any place use is desirable, including in a vehicle, at home or in the office, via attachment to a hook, doorknob, pole, post or any other suitable hanging means;
Can also be used as a portable platform to support electronic devices for entertainment.

Although the description presented heretofore contains specificities for the benefit of illustration, these should not be construed as limiting the scope of the embodiments but rather as illustrative examples of some of the several embodiments. For example, portable auto slings can be made from any suitable material(s) and in any various sizes and dimensions. Thus, the scope of the embodiments should be determined by the appended claims and their legal equivalents rather than by the examples provided.

What is claimed is:

1. A portable and adjustable sling generally for use in feeding or watering animals or passengers during travel, said sling comprising:
a body structure with a generally box-shaped bottom, a generally tapered top and a window large enough to enable access to the body contents by an animal's head or muzzle;
a rigid, stabilizing means roughly the shape and size of the bottom of said body structure such that it can comfortably fit into the bottom of the body in a flat, horizontal and generally immobile position;
an attachment means having a generally elongated, strap-like body and attachment means on each end; and
one or more attachment point means whereby said attachment means connects to the body structure.

2. The sling of claim 1 whereby said attachment means connects at one end to the sling via the attachment point means, extends around the body of a vehicle seat, and connects at the other end to the sling via the same or a second attachment point means.

3. The sling of claim 1 whereby said attachment means (such as a strap) comprises a clip-like, opening/closing means enabling opening of the attachment means, extension around the poles of a car seat headrest, and closing of the attachment means resulting in securing hanging of the sling from the vehicle headrest.

4. The sling of claim 1 further comprising:
a tethering means having a generally elongated, strap-like body and attachment means on each end, said tethering means being adjustable or otherwise extendable (such as through use of elastic) to enable snug fitting to any size vehicle seat; and
one or more tethering point means.

5. The sling of claim 4 whereby the tethering means (such as a strap) connects at one end to the sling via the tethering point means, extends around the body of a vehicle seat, and connects at the other end to the sling via the same or a second tethering point means.

6. The sling of claim 4 whereby the tethering means (such as a strap) connects at one end to the sling via the tethering point means, extends toward the bottom of a vehicle seat, and connects at the other end to a suitable attachment point on a vehicle seat or elsewhere in a vehicle.

7. The sling of claim 1 where the rigid, stabilizing means is made from high-density polyurethane.
